(19) United States
(12) Patent Application Publication
(10) Pub. No.: US 2023/0053375 A1
(43) Pub. Date: Feb. 23, 2023

(54) Method for fabricating oleophilic-hydrophobic nanofiber membrane and separation of water-in-oil emulsion using same method and waste heat

(71) Applicant: POSTECH Research and Business Development Foundation, Pohang-si (KR)

(72) Inventors: Geunbae LIM, Gyeongju-si (KR); Hyeonsu WOO, Pohang-si (KR)

(21) Appl. No.: 17/893,215

(22) Filed: Aug. 23, 2022

(30) Foreign Application Priority Data
Aug. 23, 2021 (KR) 10-2021-0110959

(51) Int. Cl. B01D 69/02; B01D 61/02; B01D 17/04; B01D 71/28; B01D 69/04; B01D 67/00; C02F 1/44

(52) U.S. Cl. CPC B01D 69/02; B01D 61/027; B01D 17/045; B01D 71/281; B01D 69/04; B01D 67/0002; C02F 1/442; B01D 2325/04; B01D 2325/0283; B01D 2325/38; B01D 2323/10; B01D 2323/39; C02F 2101/32

(57) ABSTRACT

The present invention relates to a lipophilic and hydrophobic nanofiber membrane and a method of preparing the same. The lipophilic and hydrophobic nanofiber membrane according to an exemplary embodiment may be compressed at a pressure of 10 kPa to 100 kPa and may have an average thickness of 10 μm to 1,500 μm.

### CROSS-REFERENCE TO RELATED APPLICATION

This application claims priority to and the benefit of Korean Patent Application No. 10-2021-0110959 filed in the Korean Intellectual Property Office on Aug. 23, 2021, and Korean Patent Application No. 10-2022-0105724 filed in the Korean Intellectual Property Office on Aug. 23, 2022, the entire contents of which are incorporated herein by reference.

### BACKGROUND OF THE INVENTION

### (a) Field of the Invention

The present invention relates to a lipophilic and hydrophobic nanofiber membrane and a method of preparing the same, and more particularly, to a nano-separation membrane capable of separating oil and water without additional energy and facilities.

### (b) Description of the Related Art

Separation of oil and water is classified as a significantly important technology in the industrial field. This is a technology that has a common problem to be solved in almost all business fields, for example, a manufacturing process of consumer goods such as food, pharmaceuticals, and cosmetics, as well as the chemical industry, in particular, oil refining, water treatment, waste recycling, and the like.

The common point of the fields to which the separation of oil and water is widely applied as described above is that it is possible to dissolve and remove impurities in water by adding water to oil and then performing a washing process through high-speed stirring, ultrasonic stirring, or the like in order to purify the impurities present in the oil component, and it has technical convenience of being able to separate oil and water through a specific gravity difference between oil and water after the washing process.

The separation method through the specific gravity difference enables easy separation of large particles (water droplets) in oil. However, in the case of fine water particles (water droplets) generated during stirring, there is problem in that it is significantly difficult to separate oil and water using the specific gravity difference as described above.

Usually, fine water particles whose amount is several wt % in terms of weight ratio become impurities in an oil product, and thus, a means for removing the fine water particles is essential.

A typical process in which such a problem occurs is, for example, an oil refining process. In the oil refining process, purification of unpurified crude oil is essential. In particular, chlorine ions (Cl-) in oil are a major corrosive source in various devices and storage tanks in oil refining facilities and fields of use of oil, and thus, the chlorine ions are significantly strictly removed.

The purification process in the oil refining facility is implemented as a washing process (also referred to as a desalting process) through addition and stirring of water described above, and uses a method in which impurities containing chlorine ions are removed by being moved into water because solubility of the impurities is higher in water.

Thereafter, a means for removing water added for purification is required, and at this time, the oil is heated (to 100° C.) to lower the viscosity and is separated using the specific gravity difference.

However, when water is removed using the specific gravity difference as described above, it is impossible to separate fine water particles, and additional facilities are required for the separation of the fine water particles. As a result, the facility scale and processing cost of the purification process rise rapidly.

Therefore, it is required to develop a technology for solving the above problems.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a lipophilic and hydrophobic nanofiber membrane by preparing a fiber membrane through electrospinning and then compressing the fiber membrane under specific compression conditions.

The lipophilic and hydrophobic nanofiber membrane may separate oil and water at a low temperature and atmospheric pressure without additional energy and facilities because it has uniform and dense pores.

An exemplary embodiment of the present invention provides a lipophilic and hydrophobic nanofiber membrane, wherein the lipophilic and hydrophobic nanofiber membrane is compressed at a pressure of 10 kPa to 100 kPa and has an average thickness of 10 μm to 1,500 μm.

An average pore size of the lipophilic and hydrophobic nanofiber membrane may be 500 μm or less.

More specifically, in the present exemplary embodiment, the lipophilic and hydrophobic nanofiber membrane may be compressed at a pressure of 30 kPa to 60 kPa and may have an average thickness of 200 μm to 1,000 μm.

In this case, an average pore size of the lipophilic and hydrophobic nanofiber membrane may be 5 μm to 100 μm.

A porosity of the lipophilic and hydrophobic nanofiber membrane may be 75% to 95%.

A material of the lipophilic and hydrophobic nanofiber membrane may include at least one of polystyrene and polyvinylidene fluoride.

The lipophilic and hydrophobic nanofiber membrane may be formed of fibers having a long cylindrical shape, and the fibers may have a crushed shape by being pressed against each other.

The lipophilic and hydrophobic nanofiber membrane may have a contact angle with respect to water of 100 degrees to 140 degrees when measured based on a surface of the lipophilic and hydrophobic nanofiber membrane.

A contact angle with respect to oil may not be measured based on a surface of the lipophilic and hydrophobic nanofiber membrane.

Another exemplary embodiment of the present invention provides a method of preparing a lipophilic and hydrophobic nanofiber membrane, the method including: electrospinning a nanofiber membrane material on a substrate and collecting nanofibers; and physically compressing the collected nanofibers to prepare a nanofiber membrane having a thickness of 10 μm to 1,500 μm, wherein the compressing of the collected nanofibers is performed at a pressure of 10 kPa to 100 kPa.

In the electrospinning of the nanofiber membrane material on the substrate and the collecting of the nanofibers, the electrospinning may be performed for 1 minute to 60 minutes.

The compressing of the collected nanofibers may be performed at a pressure of 10 kPa to 100 kPa, and a thickness of the prepared nanofiber membrane may be 10 μm to 1,500 μm.

According to an exemplary embodiment of the present invention, it is possible to provide a nanofiber membrane that may separate oil and water at a low temperature of 70° C. or lower and atmospheric pressure without additional energy and facilities because it has both lipophilicity and hydrophobicity and has uniform and dense pores.

Specifically, since the nanofiber membrane according to the present exemplary embodiment has lipophilicity with respect to an oil component, the oil component is easily wetted and penetrated into a fiber layer of the nanofiber membrane, and therefore, the oil component may move to (pass through) the opposite side of the nanofiber membrane.

In addition, water is restricted from moving on the surface of the nanofiber membrane having hydrophobicity, and therefore, it is impossible for water to move to (pass through) the opposite side of the nanofiber membrane.

Therefore, when the nanofiber membrane of the present exemplary embodiment is used, it is possible to easily separate the oil component and the fiber water particles.

### BRIEF DESCRIPTION OF THE DRAWINGS

FIG. 1 is a schematic view for explaining a method of preparing a lipophilic and hydrophobic nanofiber membrane according to an exemplary embodiment and applying the lipophilic and hydrophobic nanofiber membrane to a filtering device.

FIG. 2 illustrates an electrospinning process for preparing the lipophilic and hydrophobic nanofiber membrane according to the present exemplary embodiment.

FIG. 3A illustrates a result of measuring a thickness of a nanofiber membrane which is not subjected to a compression process.

FIG. 3B illustrates a result of measuring a thickness of a nanofiber membrane prepared by performing a compression process according to the present exemplary embodiment.

FIGS. 3C to 3F illustrate results of measuring cross sections of nanofiber membranes prepared by performing the compression process after electrospinning for 10 minutes, 20 minutes, 30 minutes, and 40 minutes, respectively, according to FIG. 3B. In FIG. 4A, A-1 and A-2 are a camera photograph and a micrograph of the surface of the nanofiber membrane before compression after the electrospinning for about 20 minutes, and B is an electron micrograph of the cross section of the same sample.

In FIG. 4B, C-1 and C-2 are a camera photograph and a micrograph of the surface of the nanofiber membrane which is subjected to the compression process at a pressure of about 50 kPa after electrospinning for about 20 minutes, and D is an electron micrograph of the cross section of the same sample.

FIG. 5 illustrates results of analyzing a pore size before and after the compression process.

FIG. 6A is a photograph observed after dropping a mineral oil droplet and a water droplet on the lipophilic and hydrophobic nanofiber membrane according to an exemplary embodiment.

FIG. 6B is a photograph obtained by measuring contact angles of the mineral oil droplet and the water droplet tested in FIG. 6A.

FIG. 6C illustrates results of measuring the contact angle of the water droplet with respect to each of the lipophilic and hydrophobic nanofiber membranes according to an exemplary embodiment prepared by varying an electrospinning time.

FIG. 7A illustrates a result of measuring a water separation flow rate at atmospheric pressure after applying each of the lipophilic and hydrophobic nanofiber membranes according to an exemplary embodiment prepared by varying the electrospinning time to a filtering device.

FIG. 7B illustrates a result of measuring separation efficiency of a water emulsion present in the oil component of each of the lipophilic and hydrophobic nanofiber membranes according to an exemplary embodiment prepared by varying the electrospinning time.

FIGS. 7C and 7D are photographs of an experiment of separating the water emulsion present in the oil component using each of the lipophilic and hydrophobic nanofiber membranes according to an exemplary embodiment prepared by varying the electrospinning time.

FIG. 8A illustrates an emulsion separation device used in the experiment.

In FIG. 8B, C is a photograph of the solution before and after separation, B is an optical micrograph of the emulsion solution before separation, and D is an optical micrograph of the solution after separation.

FIG. 9A is an optical micrograph of the emulsion solution before separation using the lipophilic and hydrophobic nanofiber membrane according to an exemplary embodiment.

FIG. 9B is an optical micrograph of the emulsion solution after separation using the nanofiber membrane that is not compressed after electrospinning.

FIG. 9C is an optical micrograph of the emulsion solution after separation using the lipophilic and hydrophobic nanofiber membrane according to an exemplary embodiment which is subjected to a compression process after electrospinning.

### DETAILED DESCRIPTION OF THE EMBODIMENTS

The terms “first”, “second”, “third”, and the like are used to describe various parts, components, regions, layers, and/or sections, but are not limited thereto. These terms are only used to differentiate a specific part, component, region, layer, or section from another part, component, region, layer, or section. Accordingly, a first part, component, region, layer, or section which will be described hereinafter may be referred to as a second part, component, region, layer, or section without departing from the scope of the present invention.

Terminologies used herein are to mention only a specific exemplary embodiment, and are not to limit the present invention. Singular forms used herein include plural forms as long as phrases do not clearly indicate an opposite meaning. The term “comprising” used in the specification concretely indicates specific properties, regions, integers, steps, operations, elements, and/or components, and is not to exclude the presence or addition of other specific properties, regions, integers, steps, operations, elements, and/or components.

When any part is positioned “on” or “above” another part, it means that the part may be directly on or above the other part or another part may be interposed therebetween. In contrast, when any part is positioned “directly on” another part, it means that there is no part interposed therebetween.

Unless defined otherwise, all terms including technical terms and scientific terms used herein have the same meanings as understood by those skilled in the art to which the present invention pertains. Terms defined in a generally used dictionary are additionally interpreted as having the meanings matched to the related technical document and the currently disclosed contents, and are not interpreted as ideal or very formal meanings unless otherwise defined.

According to an exemplary embodiment, a lipophilic and hydrophobic nanofiber membrane may be compressed at a pressure of 10 kPa to 100 kPa and may have an average thickness of 10 μm to 1,500 μm.

More specifically, the lipophilic and hydrophobic nanofiber membrane may be compressed at a pressure of 10 kPa to 100 kPa and then may be subjected to electrospinning for 1 minute to 60 minutes, and may have an average thickness of 10 μm to 1,500 μm.

An average pore size of the lipophilic and hydrophobic nanofiber membrane may be 500 μm or less.

More specifically, the average pore size of the lipophilic and hydrophobic nanofiber membrane may be 5 μm to 100 μm.

Meanwhile, a porosity of the lipophilic and hydrophobic nanofiber membrane according to the present exemplary embodiment may be 75% to 95%.

In the present specification, the porosity means “100%—(actual density including pores/density of material excluding pores) %”. In this case, the “actual density including pores/density of material excluding pores” means a value analyzed using a mercury intrusion method for the prepared lipophilic and hydrophobic nanofiber membrane.

The porosity of the lipophilic and hydrophobic nanofiber membrane of the present exemplary embodiment may be 75% to 95% when measured using a porosity analyzer using the mercury intrusion method. When the porosity of the lipophilic and hydrophobic nanofiber membrane satisfies the above range, it is possible to prepare a lipophilic and hydrophobic nanofiber membrane in which a shape of a nanofiber is maintained even when subjected to a compression process.

A material of the lipophilic and hydrophobic nanofiber membrane may include at least one of polystyrene and polyvinylidene fluoride. In the present exemplary embodiment, as the material of the lipophilic and hydrophobic nanofiber membrane, for example, polystyrene may be applied.

The lipophilic and hydrophobic nanofiber membrane may be formed of fibers having a long cylindrical shape, and the fibers may have a crushed shape by being pressed against each other. This will be described below using an experimental example.

The lipophilic and hydrophobic nanofiber membrane of the present exemplary embodiment may have a contact angle with respect to water of 100 degrees to 140 degrees when measured based on a surface of the lipophilic and hydrophobic nanofiber membrane. In addition, a contact angle with respect to oil may not be measured based on the surface of the lipophilic and hydrophobic nanofiber membrane. That is, since the lipophilic and hydrophobic nanofiber membrane has lipophilicity, the contact angle with respect to oil is not measured.

As described above, the nanofiber membrane according to the present exemplary embodiment may have both lipophilicity and hydrophobicity because the contact angles with respect to water and oil satisfy the above ranges. Accordingly, the oil component is easily wetted and penetrated into a fiber layer of the lipophilic and hydrophobic nanofiber membrane, and water is restricted from moving on the surface of the nanofiber membrane having hydrophobicity, and therefore, it is impossible for water to move to (pass through) the opposite side of the nanofiber membrane. As a result, it is possible to easily separate the water particles contained in the oil component.

In the present exemplary embodiment, in order to prepare a lipophilic and hydrophobic nanofiber membrane, a compression process is performed on the nanofiber membrane obtained after electrospinning under specific conditions to be described below.

As described above, the nanofiber membrane prepared by performing the compression process may have uniform and dense pores compared to the nanofiber membrane which is not subjected to the compression process after electrospinning. This may be confirmed through various experiments later.

The nanofiber membrane having uniform and dense pores may not be obtained when the nanofiber membrane is prepared only by a common electrospinning process, and may be implemented only when the specific compression conditions presented in the present exemplary embodiment are applied.

In an oil refining process, purification of unpurified crude oil is an essential process. However, in a case where water is removed using a specific gravity difference between water and oil, as described above, it is impossible to remove fine water particles having a size of several tens of micrometers to several hundreds of nanometers.

The fine water particles are not separated by the specific gravity difference and float in oil because they are significantly small in size. In addition, since surfaces of the water particles are surrounded by oil particles and the water particles are in a charged state, a repulsive force acts between the fine water particles, which makes it impossible for the fine water particles to agglomerate and grow.

As a common means for removing the fine water particles, a method of evaporating water by heating oil to a high temperature of 300° C. or lower, or a method (electrostatic process) of removing water by applying a direct current voltage of about 15,000 to 25,000 V between two electrode plates installed in an oil tank to move and aggregate the fine water particles charged toward the electrodes is used.

However, in the case of the common means, a high-voltage power source and a heating source should be used, and an explosion-proof facility and the like are added to prevent oil mist generated in this process and explosion caused by a short circuit between the electrodes. Therefore, the facility scale and processing cost of the purification process rise rapidly.

In addition, the common means is applied to a process of separating most of oil and water, in addition to the crude oil purification process in the oil refining process, and in this case, an increase in energy used and complexity of the facility are inevitably accompanied.

However, the nanofiber membrane according to the present exemplary embodiment has both lipophilicity and hydrophobicity and has uniform and dense pores, and therefore, it is possible to easily separate oil and water at a low temperature of 70° C. or lower and atmospheric pressure without additional energy and facilities.

Therefore, the lipophilic and hydrophobic nanofiber membrane according to the present exemplary embodiment may be applied not only to the oil refining process, but also to various fields in which water is required to be separated from the oil component.

According to another exemplary embodiment, there is provided a method of preparing a lipophilic and hydrophobic nanofiber membrane, the method including: electrospinning a nanofiber membrane material on a substrate and collecting nanofibers; and physically compressing the collected nanofibers to prepare a nanofiber membrane having a thickness of 10 μm to 1,500 μm, wherein the compressing of the collected nanofibers is performed at a pressure of 10 kPa to 100 kPa.

In this case, the electrospinning may be performed for 1 minute to 60 minutes. When the electrospinning time satisfies the above range, nanofibers having a diameter of 100 nm to 10 μm may be uniformly collected over the entire area.

The lipophilic and hydrophobic nanofiber membrane prepared according to an exemplary embodiment allows the oil component to pass through and the water component not to pass through, such that a water emulsion contained in the oil component may be easily separated.

In the related art, a fiber membrane prepared using electrospinning has a problem in that small water particles of several to several tens of micrometers are not separated because it has a large pore size.

However, as in the present exemplary embodiment, the nanofiber membrane is compressed under a certain pressure condition after electrospinning, the size of the pore formed in the nanofiber membrane may be reduced.

Specifically, an average pore size of the lipophilic and hydrophobic nanofiber membrane of the present exemplary embodiment may be 500 μm or less. The nanofiber membrane prepared by performing the compression process as in the present exemplary embodiment may separate significantly small water droplets (emulsion) present in the oil component. In a case where waste heat is used in the separation process, the entire system may be heated, such that fluidity of the oil component is increased, which may increase a separation rate.

The characteristics of the lipophilic and hydrophobic nanofiber membrane prepared by the method described above are the same as those described in an exemplary embodiment, and thus will be omitted herein.

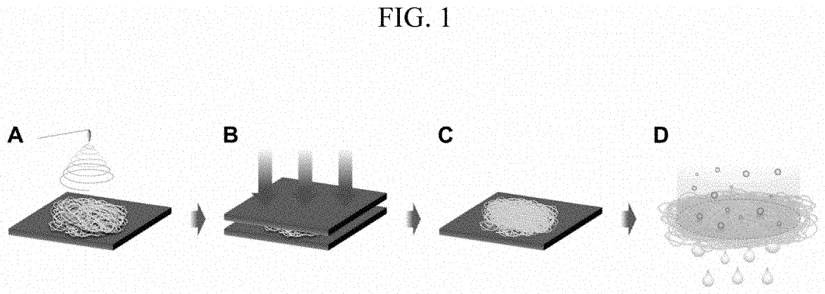

FIG. 1 is a schematic view for explaining a method of preparing a lipophilic and hydrophobic nanofiber membrane according to an exemplary embodiment and applying the lipophilic and hydrophobic nanofiber membrane to a filtering device.

Referring to FIG. 1, A illustrates a process of electrospinning a nanofiber membrane material, for example, polystyrene, on a substrate, and then collecting nanofibers.

B illustrates a process of physically compressing the polystyrene nanofibers collected as described above. C illustrates a process of obtaining a lipophilic and hydrophobic nanofiber membrane by removing a compression means. D illustrates a state in which water contained in an oil component is separated using the lipophilic and hydrophobic nanofiber membrane prepared as described above.

In a case where the lipophilic and hydrophobic nanofiber membrane prepared by the method as described above is mounted on a filtering device, a device for separating water contained in the oil component may be easily manufactured.

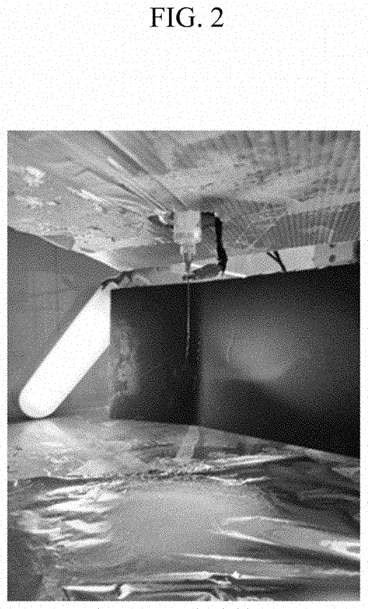

FIG. 2 illustrates an electrospinning process for preparing the lipophilic and hydrophobic nanofiber membrane according to the present exemplary embodiment.

The electrospinning may be performed, for example, under the following conditions.

(1) Polymer material: Polystyrene (PS, Mw to 192,000)

(2) Solution: 30 wt % PS+Dimethylformamide (DMF)

(3) Flow rate: 50 to 100 uL/min

(4) Voltage: 6 to 7 kV

(5) Tip-to-collector distance: 10 to 15 cm

(6) Collecting time: 1 to 60 min

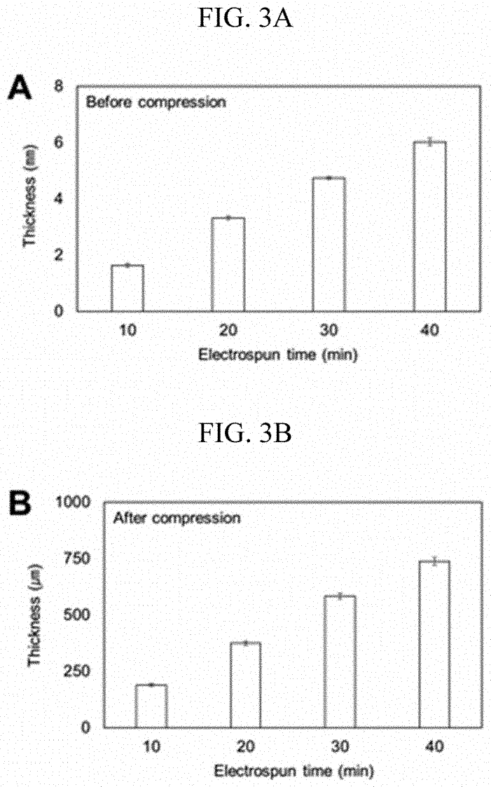

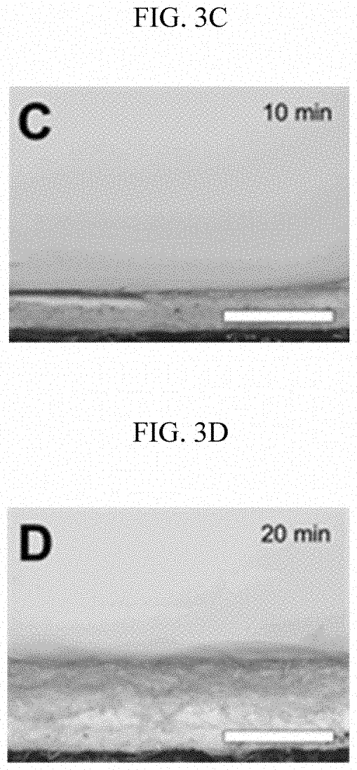

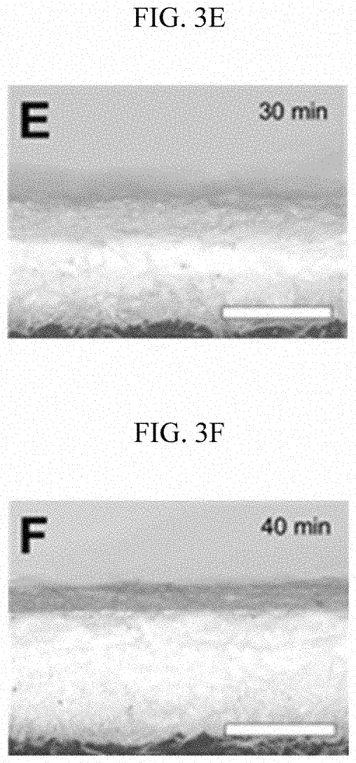

FIG. 3A illustrates a result of measuring a thickness of a nanofiber membrane which is not subjected to a compression process.

Referring to FIG. 3A, it may be confirmed that when the electrospinning is performed for 10 minutes, 20 minutes, 30 minutes, and 40 minutes, the thickness of the collected fiber membrane is increased as the collecting time is increased.

In FIG. 3A, the thicknesses are as follows:

10 minutes (1.63 mm), 20 minutes (3.32 mm), 30 minutes (4.74 mm), and 40 minutes (6.02 mm).

FIG. 3B illustrates a result of measuring a thickness of a nanofiber membrane prepared by performing a compression process according to the present exemplary embodiment.

In FIG. 3B, the thicknesses are as follows:

10 minutes (190 μm), 20 minutes (374 μm), 30 minutes (584 μm), and 40 minutes (738 μm).

FIGS. 3C to 3F illustrate results of measuring cross sections of nanofiber membranes prepared by performing the compression process after electrospinning for 10 minutes, 20 minutes, 30 minutes, and 40 minutes, respectively, according to FIG. 3B.

Referring to FIGS. 3C to 3F, it may be confirmed that even when the compression process is performed, the thickness of the fiber membrane is increased as the collecting time is increased.

The lipophilic and hydrophobic nanofiber membrane having a cross-sectional thickness as in FIG. 3C may remove water particles of at least 1 μm or more contained in the oil component.

In FIG. 4A, A-1 and A-2 are a camera photograph and a micrograph of the surface of the nanofiber membrane before compression, and B is an electron micrograph of the cross section of the nanofiber membrane before compression.

In FIG. 4B, C-1 and C-2 are a camera photograph and a micrograph of the surface of the nanofiber membrane which is subjected to the compression process, and D is an electron micrograph of the cross section of the nanofiber membrane before compression.

In the case of the nanofiber membrane which is not subjected to the compression process, referring to FIG. 4A, it may be confirmed that intervals between the fibers constituting the nanofiber membrane are significantly wide, and referring to the cross-sectional photograph (photograph B in FIG. 4A), it may be confirmed that the fiber has a long and smooth cylindrical shape having a predetermined thickness.

On the other hand, referring to FIG. 4B, in the case of the nanofiber membrane which is subjected to the compression process, it may be confirmed that intervals between the fibers constituting the nanofiber membrane are significantly tight and dense. In addition, referring to the cross-sectional photograph (photograph D in FIG. 4B), it may be confirmed that the fibers constituting the nanofiber membrane have a long cylindrical shape, and the fibers have a crushed shape by being pressed against each other.

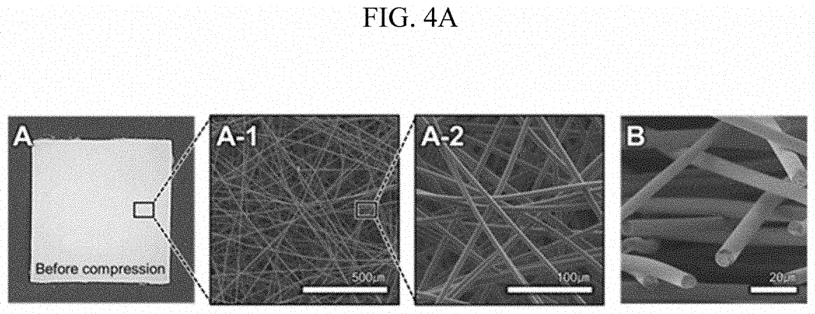

FIG. 5 illustrates results of analyzing a pore size before and after the compression process.

Referring to FIG. 5, it may be confirmed that the pore size of the nanofiber membrane according to an exemplary embodiment is reduced after the compression process regardless of the electrospinning time.

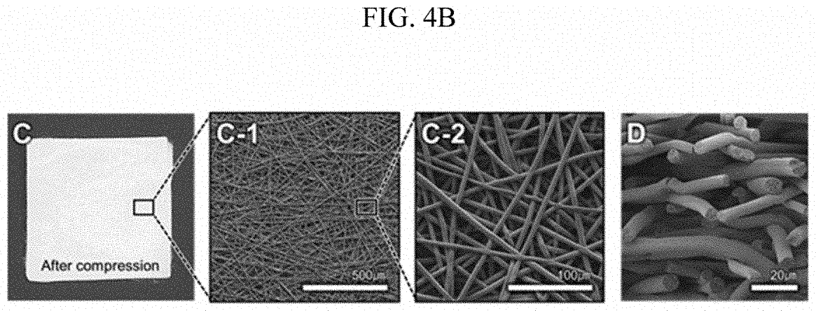

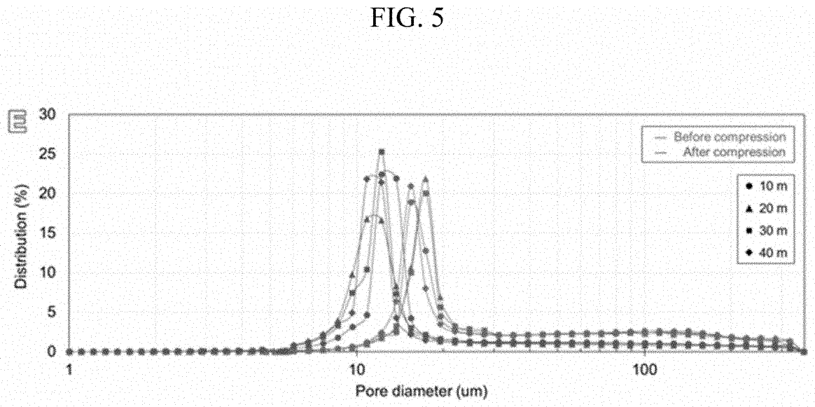

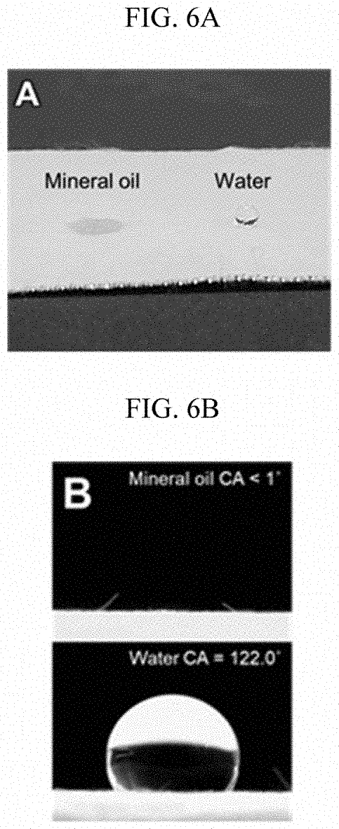

FIG. 6A is a photograph observed after dropping a mineral oil droplet and a water droplet on the lipophilic and hydrophobic nanofiber membrane according to an exemplary embodiment.

Referring to FIG. 6A, it may be confirmed that the nanofiber membrane is sufficiently wet with the mineral oil and is not wet with water.

FIG. 6B is a photograph obtained by measuring contact angles of the mineral oil droplet and the water droplet tested in FIG. 6A.

Referring to FIG. 6B, it may be confirmed that the mineral oil droplet has a contact angle close to zero because the nanofiber membrane is sufficiently wet with the mineral oil droplet. In addition, it may be confirmed that the water droplet has a contact angle of about 122 degrees.

FIG. 6C illustrates results of measuring the contact angle of the water droplet with respect to each of the lipophilic and hydrophobic nanofiber membranes according to an exemplary embodiment prepared by varying an electrospinning time.

Referring to FIG. 6C, it may be confirmed that the contact angle of the water droplet measured on the surface of each of the nanofiber membranes prepared by varying the electrospinning time is almost unchanged. Accordingly, it may be confirmed that the thickness of the nanofiber membrane may be increased according to the electrospinning time, but there is almost no change in the surface properties.

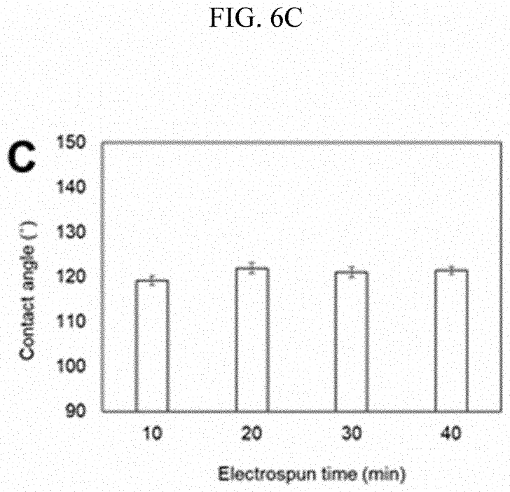

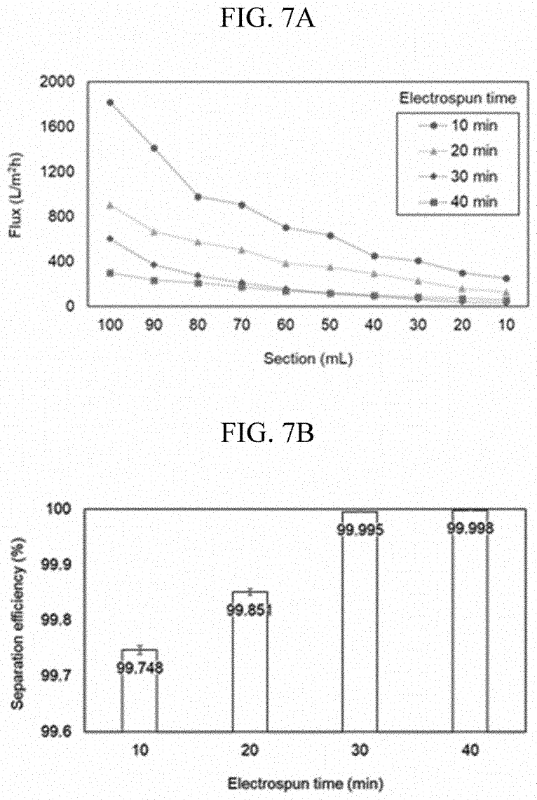

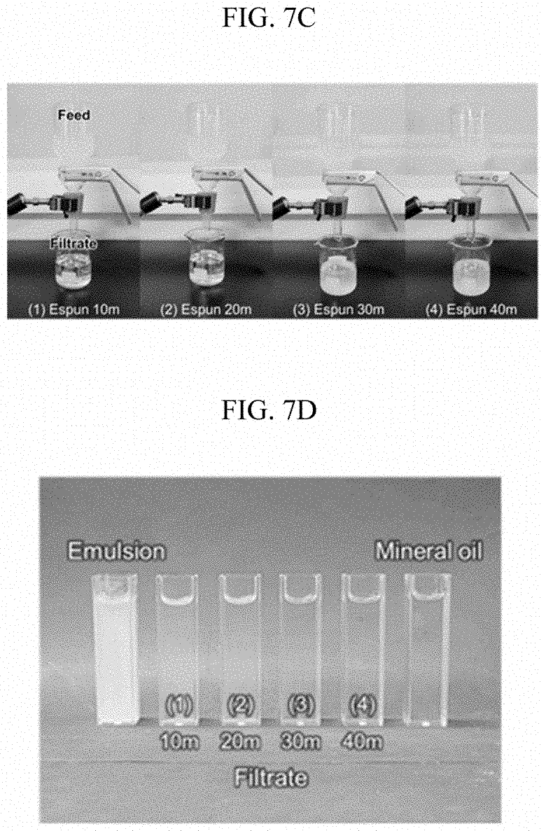

FIG. 7A illustrates a result of measuring a water separation flow rate at atmospheric pressure after applying each of the lipophilic and hydrophobic nanofiber membranes according to an exemplary embodiment prepared by varying the electrospinning time to a filtering device.

Since the separation is performed at atmospheric pressure without the need for additional pressurization or vacuum, the treatment flow rate is faster as a water head is higher, and the water head is lowered as the separation proceeds, resulting in a reduction in the treatment flow rate.

Referring to FIG. 7A, in the case of the nanofiber membrane prepared by performing compression after electrospinning for 10 minutes, it may be confirmed that a treatment flow rate is 1818.9 L/m²h at a water head of about 17 cm (100 mL) and then is reduced to 254.65 L/m²h.

In addition, in the case of the nanofiber membrane prepared by performing compression after electrospinning for 20 minutes, a treatment flow rate is reduced to 132.63 L/m²h from 909.46 L/m²h. In the case of the nanofiber membrane prepared by performing compression after electrospinning for 30 minutes, a treatment flow rate is reduced to 35.27 L/m²h from 606.30 L/m²h. Finally, in the case of the nanofiber membrane prepared by performing compression after electrospinning for 40 minutes, it may be confirmed that a treatment flow rate is reduced to 60.34 L/m²h from 303.15 L/m²h.

FIG. 7B illustrates a result of measuring separation efficiency of a water emulsion present in the oil component of each of the lipophilic and hydrophobic nanofiber membranes according to an exemplary embodiment prepared by varying the electrospinning time.

Referring to FIG. 7B, it may be confirmed that the separation efficiency of the nanofiber membrane prepared by performing compression after electrospinning for 10 minutes is about 99.748%, the separation efficiency of the nanofiber membrane prepared by performing compression after electrospinning for 20 minutes is about 99.851%, the separation efficiency of the nanofiber membrane prepared by performing compression after electrospinning for 30 minutes is about 99.995%, and the separation efficiency of the nanofiber membrane prepared by performing compression after electrospinning for 40 minutes is about 99.998%. That is, it may be confirmed that the separation efficiency of the water emulsion is increased as the electrospinning time is increased.

FIGS. 7C and 7D are photographs of an experiment of separating the water emulsion present in the oil component using each of the lipophilic and hydrophobic nanofiber membranes according to an exemplary embodiment prepared by varying the electrospinning time.

Referring to FIGS. 7C and 7D, it may be confirmed that the turbidity of the permeated solution is decreased as the nanofiber membrane is subjected to electrospinning for a long time.

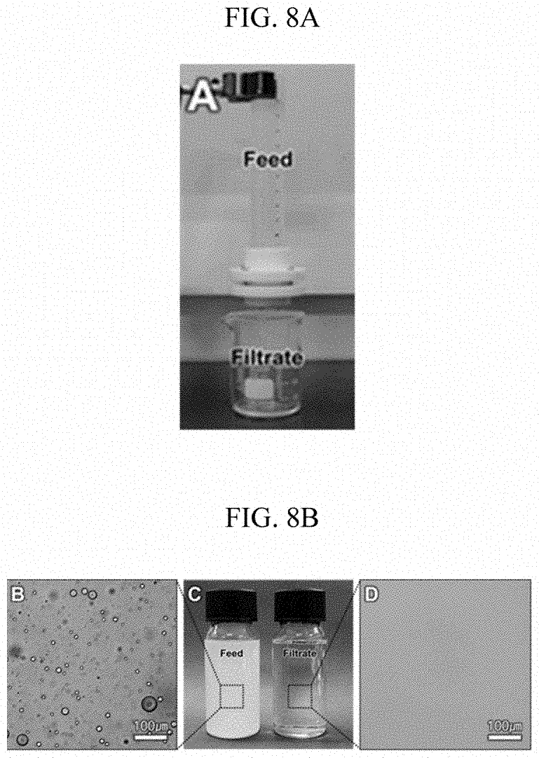

FIG. 8A illustrates an emulsion separation device used in the experiment.

In FIG. 8B, C is a photograph of the solution before and after separation, B is an optical micrograph of the emulsion solution before separation, and D is an optical micrograph of the solution after separation.

Referring to FIG. 8B, it may be confirmed that after the oil component containing water is separated using the lipophilic and hydrophobic nanofiber membrane according to an exemplary embodiment, the water droplets present in the oil component are removed.

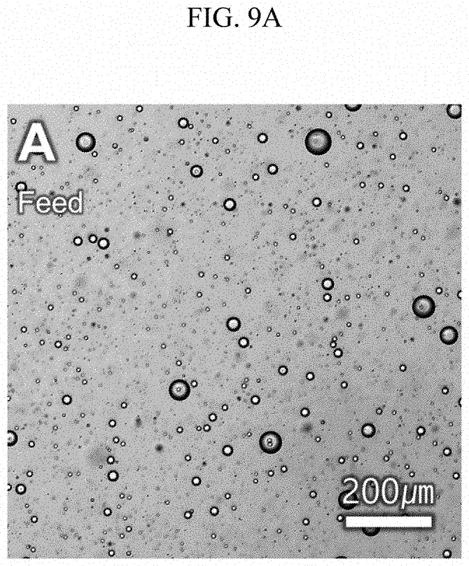

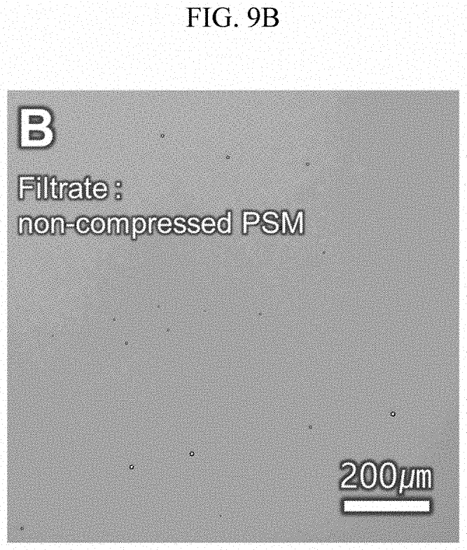

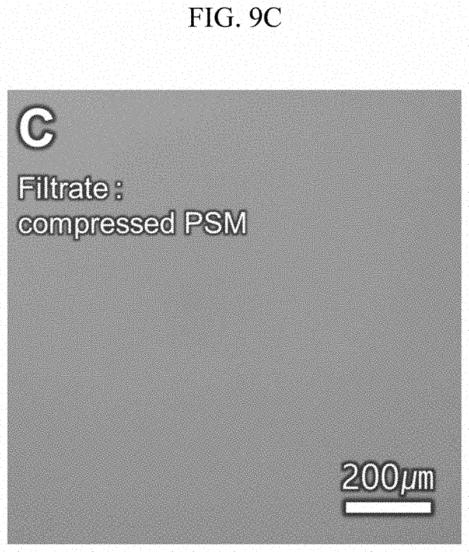

FIG. 9A is an optical micrograph of the emulsion solution before separation using the lipophilic and hydrophobic nanofiber membrane according to an exemplary embodiment.

FIG. 9B is an optical micrograph of the emulsion solution after separation using the nanofiber membrane that is not compressed after electrospinning.

The size of the fine water droplet that may be observed in FIG. 9B is about 1 to 5 micrometers.

FIG. 9C is an optical micrograph of the emulsion solution after separation using the lipophilic and hydrophobic nanofiber membrane according to an exemplary embodiment which is subjected to a compression process after electrospinning.

It may be confirmed that no water droplets are observed in FIG. 9C.

That is, referring to FIGS. 9B and 9C, in the case of using the nanofiber membrane which is not subjected to the compression process, it may be confirmed that water droplets smaller than a few micrometers are not removed.

The present invention is not limited to the exemplary embodiments, but may be manufactured in various different forms, and it will be apparent to those skilled in the art to which the present invention pertains that various modifications and alterations may be made without departing from the spirit or essential feature of the present invention. Therefore, it is to be understood that the exemplary embodiments described hereinabove are illustrative rather than being restrictive in all aspects.

What is claimed is:

1. A lipophilic and hydrophobic nanofiber membrane, wherein the lipophilic and hydrophobic nanofiber membrane is compressed at a pressure of 10 kPa to 100 kPa and has an average thickness of 10 μm to 1,500 μm.

2. The lipophilic and hydrophobic nanofiber membrane of claim 1, wherein:
an average pore size of the lipophilic and hydrophobic nanofiber membrane is 500 μm or less.

3. The lipophilic and hydrophobic nanofiber membrane of claim 2, wherein:
the average pore size of the lipophilic and hydrophobic nanofiber membrane is 5 μm to 100 μm.

4. The lipophilic and hydrophobic nanofiber membrane of claim 3, wherein:
the lipophilic and hydrophobic nanofiber membrane is compressed at a pressure of 30 kPa to 60 kPa and has an average thickness of 200 μm to 1,000 μm.

5. The lipophilic and hydrophobic nanofiber membrane of claim 1, wherein:
a porosity of the lipophilic and hydrophobic nanofiber membrane is 75% to 95%.

6. The lipophilic and hydrophobic nanofiber membrane of claim 1, wherein:
a material of the lipophilic and hydrophobic nanofiber membrane includes at least one of polystyrene and polyvinylidene fluoride.

7. The lipophilic and hydrophobic nanofiber membrane of claim 1, wherein:
the lipophilic and hydrophobic nanofiber membrane is formed of fibers having a long cylindrical shape, and the fibers have a crushed shape by being pressed against each other.

8. The lipophilic and hydrophobic nanofiber membrane of claim 1, wherein:
the lipophilic and hydrophobic nanofiber membrane has a contact angle with respect to water of 100 degrees to 140 degrees when measured based on a surface of the lipophilic and hydrophobic nanofiber membrane.

9. The lipophilic and hydrophobic nanofiber membrane of claim 1, wherein:
a contact angle with respect to oil is not measured based on a surface of the lipophilic and hydrophobic nanofiber membrane.

10. A method of preparing a lipophilic and hydrophobic nanofiber membrane, the method comprising:
electrospinning a nanofiber membrane material on a substrate and collecting nanofibers; and
physically compressing the collected nanofibers to prepare a nanofiber membrane having a thickness of 10 μm to 1,500 μm,
wherein the compressing of the collected nanofibers is performed at a pressure of 10 kPa to 100 kPa.

11. The method of claim 10, wherein:
in the electrospinning of the nanofiber membrane material on the substrate and the collecting of the nanofibers,
the electrospinning is performed for 1 minute to 60 minutes.

12. The method of claim 10, wherein:
the compressing of the collected nanofibers is performed at a pressure of 10 kPa to 100 kPa, and
a thickness of the prepared nanofiber membrane is 10 μm to 1,500 μm.
